(19) United States
(12) Patent Application Publication
(10) Pub. No.: US 2025/0077331 A1
(43) Pub. Date: Mar. 6, 2025

(54) LOG RECORD ANALYSIS USING SIMILARITY DISTRIBUTIONS OF CONTEXTUAL LOG RECORD SERIES

(71) Applicant: BMC Software, Inc., Houston, TX (US)

(72) Inventors: Vikas Prasad, Pune (IN); Ajoy Kumar, Santa Clara, CA (US)

(21) Appl. No.: 18/241,095

(22) Filed: Aug. 31, 2023

(51) Int. Cl. G06F 11/07

(52) U.S. Cl. CPC G06F 11/079; G06F 11/0709

(57) ABSTRACT

A plurality of textual log records characterizing operations occurring within a technology landscape may be received and converted into numerical log record vectors. For a current log record vector and a preceding set of log record vectors of the numerical log record vectors, a similarity series may be computed that includes a similarity measure for each of a set of log record vector pairs, with each log record vector pair including the current log record vector and one of the preceding set of log record vectors. A similarity distribution of the similarity series may be generated, and an anomaly in the operations occurring within the technology landscape may be detected, based on the similarity distribution.

### TECHNICAL FIELD

This description relates to log record analysis.

### BACKGROUND

Many companies and other entities have extensive technology landscapes that include numerous information technology (IT) assets, including hardware and software. It is often required for such assets to perform at high levels of speed and reliability, while still operating in an efficient manner. For example, various types of computer systems are used by many entities to execute mission critical applications and high volumes of data processing, across many different workstations and peripherals. In other examples, customers may require reliable access to system resources.

Various types of system monitoring methods are used to detect, predict, prevent, mitigate, or cure system faults that might otherwise disrupt or prevent monitored IT assets, such as executing applications, from achieving system goals. For example, it is possible to monitor various types of log records characterizing aspects of system performance, such as application performance. The log records may be used to train one or more machine learning (ML) models, which may then be deployed to characterize future aspects of system performance.

Such log records may be automatically generated in conjunction with system activities. For example, an executing application may be configured to generate a log record each time a certain operation of the application is attempted or completes.

In more specific examples, log records are generated in many types of network environments, such as network administration of a private network of an enterprise, as well as in the use of applications provided over the public internet or other networks. This includes where there is use of sensors, such as internet of things devices (IoT) to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). Log records are also generated in the use of individual IT components, such as a laptops and desktop computers and servers, in mainframe computing environments, and in any computing environment of an enterprise or organization conducting network-based IT transactions, such as well as in executing applications, such as containerized applications executing in a Kubernetes environment or execution by a web server, such as an Apache web server.

Consequently, a volume of such log records may be very large, so that corresponding training of a ML model(s) may consume excessive quantities of time, memory, and/or processing resources. Moreover, such training may be required to be repeated at defined intervals, or in response to defined events, which may further exacerbate difficulties related to excessive resource consumption. If the training is not repeated frequently enough, then outputs of the trained ML models may become more inaccurate over time. In other words, such conventionally trained ML models may not be sufficiently adaptable to changing circumstances in an underlying technology landscape.

### SUMMARY

According to one general aspect, a computer program product may be tangibly embodied on a non-transitory computer-readable storage medium and may include instructions. When executed by at least one computing device, the instructions may be configured to cause the at least one computing device to receive textual log records characterizing operations occurring within a technology landscape and convert the textual log records into numerical log record vectors. The instructions, when executed, may be configured to cause the at least one computing device to compute, for a current log record vector and a preceding set of log record vectors of the numerical log record vectors, a similarity series that includes a similarity measure for each of a set of log record vector pairs, wherein each log record vector pair includes the current log record vector and one of the preceding set of log record vectors. The instructions, when executed, may be configured to cause the at least one computing device to generate a similarity distribution of the similarity series, and detect an anomaly in the operations occurring within the technology landscape, based on the similarity distribution.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompa-nying drawings and the description below. Other features will be apparent from the description and drawings, and from the claims.

### BRIEF DESCRIPTION OF THE DRAWINGS

FIG. 1 is a block diagram of a system for log record analysis using similarity distributions of contextual log record series.

FIG. 2 is a flowchart illustrating example operations of the monitoring system of FIG. 1.

FIG. 3 is a block diagram of a more detailed example implementation of the system of FIG. 1.

FIG. 4 illustrates a first example window of embedded log records with similarity scores.

FIG. 5 illustrates a second example window of embedded log records with similarity scores.

FIG. 6 illustrates a first example similarity distribution obtained from a similarity series of the types of similarity windows of FIGS. 4 and 5.

FIG. 7 illustrates a second example similarity distribution obtained from a similarity series of the types of similarity windows of FIGS. 4 and 5.

FIG. 8 is a more detailed flowchart illustrating example operations for FIGS. 3-7.

FIG. 9 illustrates first example log records analyzed using described techniques, compared to analysis of the same log records using conventional techniques.

FIG. 10 illustrates a second example log record analyzed using described techniques, compared to analysis of the same log record using conventional techniques.

FIG. 11 illustrates third example log records analyzed using described techniques, compared to analysis of the same log records using conventional techniques.

FIG. 12 illustrates fourth example log records analyzed using described techniques, compared to analysis of the same log records using conventional techniques.

FIG. 13 is a graph illustrating logs graphed in time embedding space for pattern insights.

### DETAILED DESCRIPTION

Described systems and techniques provide efficient and effective log record analysis in real time or near real time, in a manner that is accurate and adaptive, while using reduced quantities of computer resources in comparison to conventional techniques. Moreover, described techniques do not require the types of extensive and regular training of large-scale ML models required by such conventional techniques.

A stream or series of log records generated by or for a particular component or system (or type of component or system) may be expected to exhibit similarities among included log records over a period of time. Described systems and techniques characterize a nature, type, and extent of such similarities, while also detecting and characterizing changes in such similarities, to thereby determine potential anomalies in operations of the underlying component(s) and/or system(s).

For example, a component may generate a log record every minute to characterize operations of the component. Such component operations may demonstrate steady state, status quo, or normal operations of the component, so that resulting log records reflect such normal operating conditions for the component.

As noted above, it is possible to train a ML model to characterize normal operations for such a component, so that the trained ML models may detect abnormal operations when such abnormal operations occur. As also noted, however, such training is time and resource-intensive, and the resulting trained ML models may be unacceptably slow in characterizing current log records. As systems increase in size and complexity, such difficulties in training and implementing such ML models increase. Moreover, as systems change over time, it is difficult to update (e.g., re-train) such ML models, so that such ML models are not sufficiently adaptive to changing technology landscapes.

As set forth in detail, below, described techniques convert textual log records into multi-dimensional vectors using an embedding model. In other words, each textual log record is converted into a numerical representation that is positioned within a vector space, so that a context of each log record is maintained and a pairwise similarity between any two log records may quickly, easily, and accurately be determined.

For example, a first textual log record and a second textual log record may be converted into a first embedded vector and a second embedded vector, respectively, within a common vector space. Then, a similarity (e.g., a cosine similarity) may be calculated between the first and second vector. Such pairwise similarity calculations may be performed between a single (e.g., current) log record and each of a plurality or window of preceding log records. For example, similarity calculations may be performed between a current vector (log record) and a preceding N number of vectors/log records, to obtain N number of similarities/similarity measures.

Resulting N number of similarities therefore define a similarity series of the N number of similarities. Each such similarity series has a similarity distribution that may be characterized or analyzed using various distribution analysis techniques to determine potential anomalies, patterns, or other insights with respect to the log records and underlying components. For example, such a similarity distribution may be analyzed with respect to one or more static distribution thresholds that are defined to determine acceptable or unacceptable levels of similarity of included log records.

These techniques may be repeated for a second (new or current) log record to obtain a second similarity series of N number of similarities, which thus demonstrates a second similarity distribution across a second window of preceding log records. The second similarity distribution may again be analyzed using one or more of the various distribution analysis techniques to determine potential anomalies, patterns, or other insights with respect to the log records and underlying components. Moreover, as multiple similarity distributions are accumulated for multiple pluralities or windows of log records, distribution analyses techniques may be used that leverage the availability of such multiple pluralities or windows of log records. For example, such similarity distributions may be analyzed for preceding similarity series to determine one or more dynamic distribution thresholds, which may then be applied to a current similarity distribution of a current similarity series to determine acceptable or unacceptable levels of similarity of log records within the current similarity series.

Therefore, in contrast to existing, conventional techniques, described techniques leverage log record similarities to analyze log records at real time or near real time, using an architecture that does not require trained ML models to analyze the log records to determine normal or abnormal (e.g., anomalous) operations. Described techniques therefore reduce memory overhead and requirements for regular training, while providing adaptive outcomes with high accuracy, high speed, and low resource requirements.

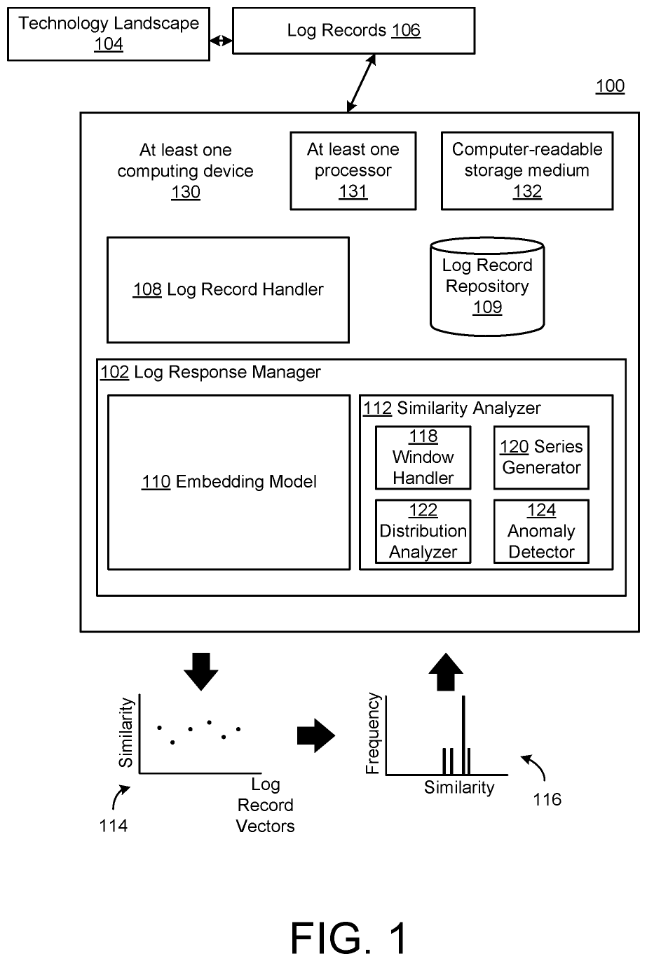

FIG. 1 is a block diagram of a monitoring system 100 for log record analysis using similarity distributions of contextual log record series. In FIG. 1, a log response manager 102 is configured to provide the type of log record analysis just described, to enable fast, accurate, adaptable anomaly detection, while conserving the use of associated computational resources.

In more detail, in FIG. 1, a technology landscape 104 may represent or include any suitable source of log records 106 that may be processed by the log response manager 102. A log record handler 108 receives the log records 106 over time and stores the log records 106 in one or more suitable storage locations, represented in FIG. 1 by a log record repository 109.

For example, as referenced above, the technology landscape 104 may include many types of network environments, such as network administration of a private network of an enterprise, or an application provided over the public internet or other network. Technology landscape 104 may also represent scenarios in which sensors, such as internet of things devices (IoT), are used to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). In some cases, the technology landscape 104 may include, or reference, an individual IT component, such as a laptop or desktop computer or a server. In some embodiments the technology landscape 104 may represent a mainframe computing environment, or any computing environment of an enterprise or organization conducting network-based IT transactions.

The log records 106 may thus represent any corresponding type(s) of file, message, or other data that may be captured and analyzed in conjunction with operations of a corresponding network resource within the technology landscape 104. For example, the log records 106 may include text files that are produced automatically in response to pre-defined events experienced by an application, or at pre-defined times. For example, in a setting of online sales or other business transactions, the log records 106 may characterize a condition of many servers being used. In a healthcare setting, the log records 106 may characterize either a condition of patients being monitored or a condition of IoT sensors being used to perform such monitoring. Similarly, the log records 106 may characterize machines being monitored, or IoT sensors performing such monitoring, in manufacturing, industrial, oil and gas, energy, or financial settings.

In FIG. 1, the log record handler 108 may ingest the log records 106 for storage in the log record repository 109. For purposes of FIG. 1, the log record repository 109 may represent a corpus of collected or historical log records, as well as one or more sets of log records most-recently received by the log record handler 108.

As referenced above, a quantity of log records 106 generated by the technology landscape 104 may be frequent and voluminous. For example, an executing application may be configured to generate a log record on a pre-determined time schedule. Such applications may be executing continuously or near-continuously, and may be executing across multiple tenants, so that hundreds of millions of log records 106 may accumulate every day. Using conventional techniques, computing resources devoted to training a corresponding ML model may require one or more days of total training time for expected volumes of log records 106.

In many cases, the log records 106 may be highly repetitive. For example, log records 106 produced for an application may contain the same or similar terminology. In a more specific example, some log records 106 may relate to user log-in activities collected across many users attempting to access network resources. Such log records are likely to be similar and may differ primarily in terms of content that is likely to be non-substantive, such as dates/times of attempted access or identities of individual users.

As referenced above, and described in detail, below, the log response manager 102 may be configured to leverage the similarity of the log records 106 to detect anomalies in a manner that does not require the training of corresponding ML models such as required by conventional techniques.

In particular, in the example of FIG. 1, the log response manager 102 includes an embedding model 110. As described in detail, below, the embedding model 110 may be configured to convert the textual log records from the log record repository 109 to numerical vector representations within a defined vector space. As a result, the embedding model retains a context of such textual log records while enabling fast and meaningful similarity comparisons between any pair of converted log records 106.

For example, the embedding model 110 may implement natural language processing techniques, such as Word2vec, GloVe (Global vectors for word representation), or FastText, which use deep learning (e.g., a neural network model) to determine similarities and associations between and among words, phrases, and expressions included in the log record repository 109.

In other words, the embedding model 110 may be configured to input text from each log record of the textual log records 106 and output a corresponding vector representation thereof. Log records 106 that contain similar (e.g., synonymous) terms are embedded at positions within the vector space that are close to one another. Thus, a context of each log record may be maintained with respect to other log records 106, while enabling fast and accurate similarity comparisons between pairs of vectors (and thus of underlying log records 106).

The embedding model 110 may be trained using log records 106 from the log record repository 109. Such training is generally faster, less resource-intensive, and more straightforward than training ML models for detection of anomalies within the log records 106. Moreover, once trained, subsequent updates to the embedding model 110 are relatively few and infrequent compared to the types of training updates required for ML models for anomaly detection, since the terminology of log records generally changes much less frequently than operational characteristics of components and/or resources of the technology landscape 104.

Additionally, the embedding model 110 may be configured to characterize text from textual log records 106 across many different factors or dimensions, to provide more precise and more fine-grained characterizations of the log record text. In other words, the embedding model 110 may provide vector representations of log records 106 that maintain a high degree of the context of the log records 106. For example, in the following examples, the embedding model 110 may be configured to use a 300-dimension vector space.

Nonetheless, as the resulting vector representations are numerical in nature, it is possible to compare and otherwise process the vector representations in a manner that is fast and that does not consume excessive computational resources. For example, a similarity analyzer 112 may be configured to determine a degree of similarity between any two embedded vectors representing two corresponding log records 106.

As shown conceptually in FIG. 1, and as described in detail, below, the similarity analyzer 112 may be configured to receive embedded vectors from the embedding model, representing a set of most-recently received log records 106, and construct a similarity series 114 therefrom. The similarity series 114 may be determined to have a similarity distribution 116. Using one or more such similarity distributions, the similarity analyzer 112 may be configured to determine anomalies in the log records 106, or to infer or determine other insights or patterns within the received log records.

For example, the similarity analyzer 112 may include a window handler 118. The window handler 118 may be configured to define a window or set of most-recent log records with respect to a current log record. Log records 106 within the window may be updated each time a new log record is received as a log record vector from the embedding model 110. For example, the window handler 118 may define a window size of N, where N may equal 10, 100, 200, or any suitable or desired value.

A series generator 120 may be configured to generate the similarity series 114 for a current window or set of log record vectors, relative to a most-recent or current log record vector that has been received. For example, a set of log record vectors numbered 1, 2, 3, 4, 5, 6, 7 may have been received, with the log record vector 7 being the most recent log record vector. The series generator 120 may then compute a pairwise similarity between the most-recent log record vector 7 and each of the preceding log record vectors 1 through 6. That is, the series generator 120 may calculate pairwise similarities between log record vector pairs 1, 7; 2, 7; 3, 7; 4, 7; 5, 7; and 6, 7, thereby resulting in 6 similarity measurements.

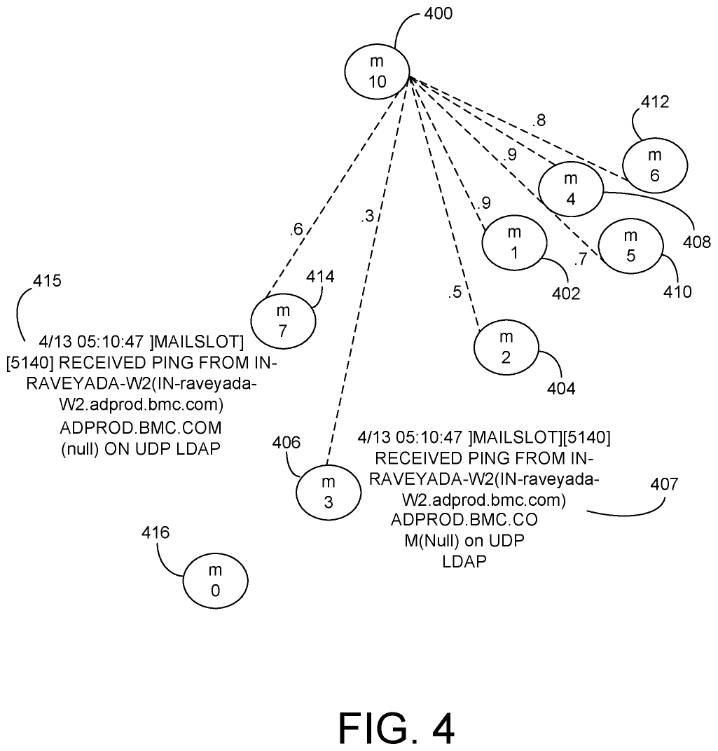

More detailed examples of such computations are provided below, e.g., with respect to FIGS. 4 through 7. In general, however, the series generator 120 may use any suitable similarity calculation to compute the above-referenced pairwise similarities. For example, the series generator 120 may calculate the pairwise similarities using the cosine similarity measure. Perhaps depending on the type of embedding model 110 used, other similarity measures may be used as well, including, e.g., the Manhattan distance, the Euclidean or Pythagorean distance, or the Minkowski distance.

The similarity series 114 thus plots the similarities of each log record vector pair. Since each log record vector pair is defined with respect to the most-recent or current log record vector, the similarity series 114 may be graphed with respect to all other log record vectors included within the window or set of log record vectors. For example, in the example above, a similarity of the pair 1, 7 may be graphed with respect to the log record vector 1, a similarity of the pair 2, 7 may be graphed with respect to the log record vector 2, a similarity of the pair 3, 7 may be graphed with respect to the log record vector 3, and so on until a similarity of the pair 6, 7 is graphed with respect to the log record vector 6. Thus, the similarity series 114 includes six similarity measures.

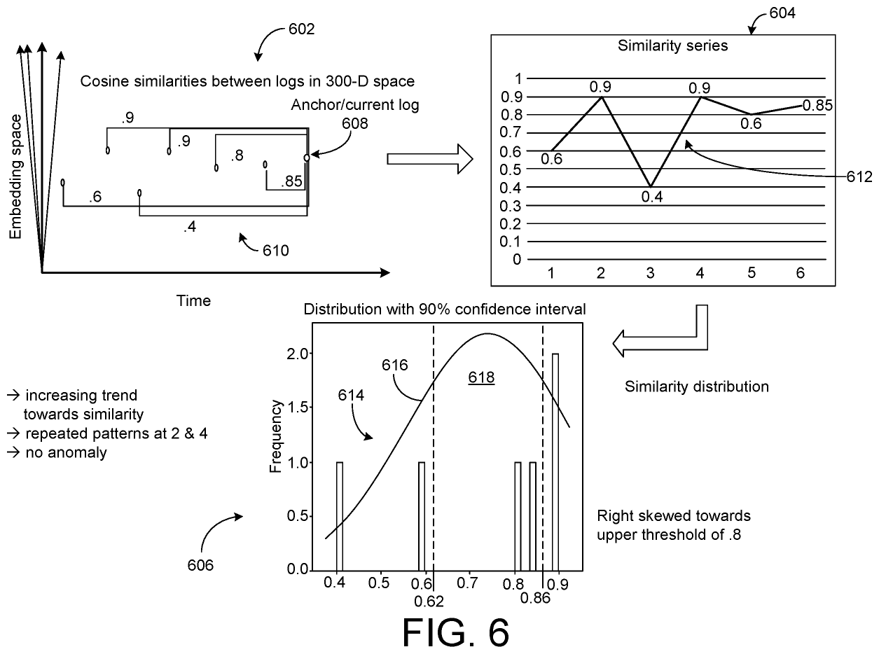

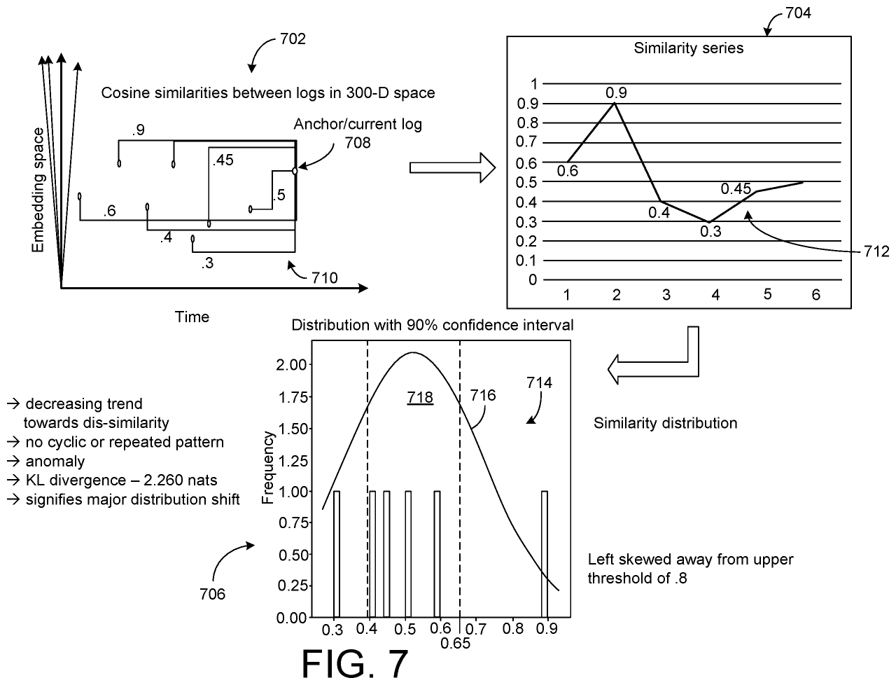

A distribution analyzer 122 may be configured to determine the similarity distribution 116. For example, as described in detail, below, e.g., with respect to FIGS. 6 and 7, the similarity distribution 116 may demonstrate an increasing trend towards greater or lesser similarities.

The distribution analyzer 122 may also use various statistical techniques to construct or characterize the similarity distribution 116. For example, the distribution analyzer 122 may calculate an average similarity, a moving average, a normal distribution, or an exponential distribution, or may apply a Kalman filter.

An anomaly detector 124 may thus be configured to analyze the similarity distribution 116 to determine the presence of an anomaly, which may correspond, e.g., to some malfunction or potential malfunction in an underlying component(s) related to the log records 106 being analyzed. For example, a similarity threshold may be determined, and an anomaly may be detected based on comparisons of the similarity distribution 116 to the similarity threshold.

For example, in a simplified example, a static similarity threshold may be set, which may be pre-defined or not. Then, the anomaly detector 124 may detect an anomaly when the similarity distribution 116 fails to meet or exceed the static similarity threshold. For example, an aggregate similarity measure of the similarity distribution (e.g., an average similarity) may be required to be at or above the static similarity threshold.

In other examples, a dynamic similarity threshold may be determined by the anomaly detector 124. For example, a dynamic similarity threshold may be determined based on a statistical analysis of the similarity distribution 116, and/or using one or more preceding or previous similarity distributions, e.g., calculated for one or more log record vectors received prior to the most-recent or current log record vector being analyzed. For example, the dynamic similarity threshold may conceptually represent a normal or expected lower bound of similarity, based on historical similarity distributions, so that a failure of the current similarity distribution 116 to meet this dynamic similarity threshold represents a potential anomaly. In some cases, techniques that may be considered to be machine learning or relevant to machine learning (e.g., Kalman filtering) may be used to determine the dynamic similarity threshold, but use of such techniques are an advancement over conventional techniques because they do not require the types of large-scale pre-training used by conventional anomaly detection methodologies.

In FIG. 1, the log response manager 102 is illustrated as being implemented using at least one computing device 130, including at least one processor 131, and a non-transitory computer-readable storage medium 132. That is, the non-transitory computer-readable storage medium 132 may store instructions that, when executed by the at least one processor 131, cause the at least one computing device 130 to provide the functionalities of the log response manager 102 and related functionalities.

For example, the at least one computing device 130 may represent one or more servers. For example, the at least one computing device 130 may be implemented as two or more servers in communications with one another over a network. Accordingly, for example, the log record handler 108 and the log response manager 102 may be implemented using separate devices in communication with one another.

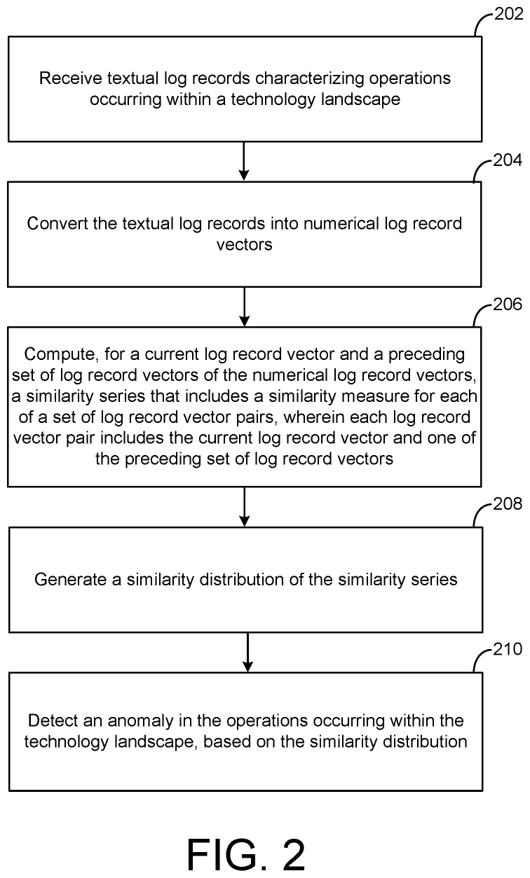

FIG. 2 is a flowchart illustrating example operations of the monitoring system 100 of FIG. 1. In the example of FIG. 2, operations 202 to 210 are illustrated as separate, sequential operations. In various implementations, the operations 202 to 210 may include sub-operations, may be performed in a different order, may include alternative or additional operations, or may omit one or more operations. Further, in all such implementations, included operations may be performed in an iterative, looped, nested, or branched fashion.

In FIG. 2, textual log records characterizing operations occurring within a technology landscape may be received (202). For example, the log record handler or the embedding model 110 may receive the log records 106, directly or view the log record repository 109.

The textual log records may be converted into numerical log record vectors (204). For example, the embedding model 110 may convert (e.g., embed) the textual log records into a multi-dimensional vector space to obtain numerical representations of the textual log records that maintain a shared context of the textual log records. For example, a first log record related to “user can't log in” may be embedded within the vector space close to a second log record related to “user can't access the account,” because the embedding model 110 implicitly recognizes the shared context of the two log records, even though the semantics, syntax, and/or terminology may be different.

For a current log record vector and a preceding set of log record vectors of the numerical log record vectors, a similarity series may be computed that includes a similarity measure for each of a set of log record vector pairs, wherein each log record vector pair includes the current log record vector and one of the preceding set of log record vectors (206). For example, as described above, the window handler 118 of the similarity analyzer 112 may define a window size of, e.g., 10 log records, or of a defined time window during which all received log records 106 are accumulated. A most-recent or current log record vector (e.g., the 10^{th} log record vector) may be paired with each preceding log record vector (e.g., log record vectors 1 through 9) to obtain 9 log record vector pairs. The series generator 120 may then determine a pairwise similarity measure for each log record vector pair, to thereby obtain a similarity series (similar to the similarity series 114 of FIG. 1).

A similarity distribution of the similarity series may be generated (208). For example, the distribution analyzer 122 may determine a similarity distribution similar to the similarity distribution 116 of FIG. 1. As described herein, the similarity distribution may refer to any characterization or aspect of the similarity series, including a trend, a pattern, an outlier, a frequency, a magnitude, or a spread of one or more of the similarity measures of the similarity series, or any associated analysis of the similarity series that identifies such characteristics or aspects. Generating the similarity distribution may also include attempts to fit the similarity distribution to a known distribution, such as the normal distribution. Other examples for generating and/or analyzing the similarity distribution(s) are provided below, or would be apparent.

An anomaly may be detected in the operations occurring within the technology landscape, based on the similarity distribution (210). For example, the anomaly detector 124 may detect, from the similarity distribution, threshold violations that indicate a potential anomaly. As described, related thresholds may be set statically, or may be determined dynamically. For example, dynamic thresholds may be set based on norms established using one or more previously calculated similarity distributions or similarity series. Detected anomalies may thus include not only actual or potential malfunctions of landscape components, but also abnormal or suboptimal operations that may be improved or optimized.

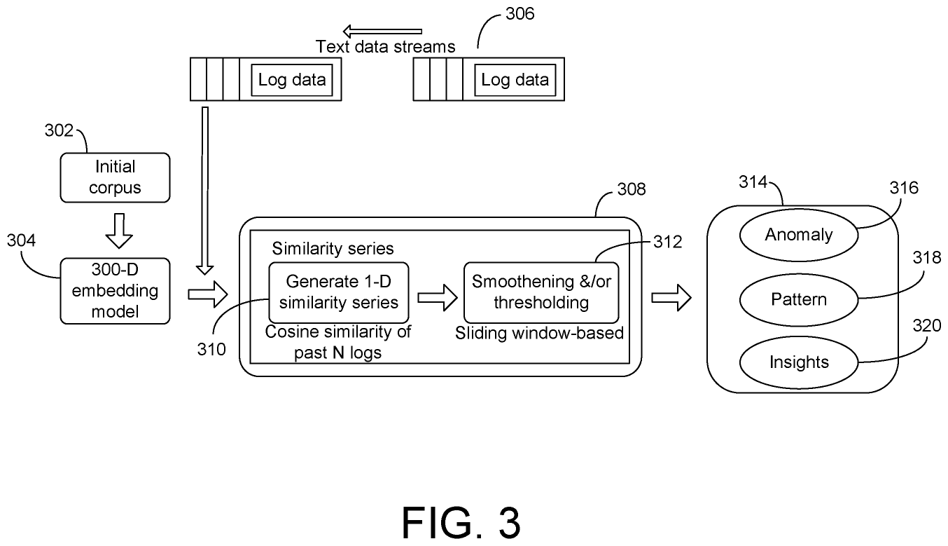

FIG. 3 is a block diagram of a more detailed example implementation of the system of FIG. 1. In the example of FIG. 3, an initial corpus 302 of textual log records may be used to train a 300 dimension (300-D) embedding model 304. For example, the 300-D embedding model 304 may be implemented using a neural network based model, such as, e.g., Doc2Vec, Word2 Vec, or Bert (Bidirectional Encoder Representations from Transformers) models.

A number of dimensions used is configurable, and 300 is merely an example. In general, a number of dimensions may be chosen that is sufficient to maintain a context of the text of log records 106 of the initial corpus 302.

A stream of current, text data of log records 306 may be received and processed by the embedding model 304 to obtain corresponding log record vectors with a vector space of the 300-D embedding model 304. A temporal similarity series 308 may then be provided by generating a 1-D similarity series 310 using for example, cosine similarity scores generated with respect to a defined window or set of the past “N” log records 106 or corresponding log record vectors. As a matter of terminology, the window or set “N” may refer to a total number of log record vectors including a current log record vector (e.g., N=10 may include the current log record vector, so that N-1=9 log record vector pairs are established), or may refer to a total number of log record vectors other than a most-recent or current log record vector (e.g., N=10 may not include a current log record vector, so that N=10 log record vector pairs are established). As described with respect to FIGS. 1 and 2, similarity scores (e.g., cosine similarity scores) may be generated for corresponding log record vector pairs in which the current log record vector is paired with one of the preceding set of log record vectors.

A resulting similarity distribution 312 may thus be processed, including, e.g., any smoothening and/or thresholding techniques. In this way, the temporal similarity series 308 may be used to provide various analysis outputs 314, including anomaly detection 316, pattern detection 318, or other insights 320 into a nature and operations of the various underlying components for which the stream of current, text data of log records 306 were generated.

FIG. 4 illustrates a first example window of embedded log records 106 with similarity scores. In the example of FIG. 4, a node 400 represents a node for a most-recent or current log record vector (and associated or underlying log record), which is presumed to be received at a time t1. Similarly, a node 404, a node 406, a node 408, a node a 410, a node 412, and a node 414 represent previously-received log records 106 and associated log record vectors of a window or set of log record vectors. Thus, in FIG. 4, N=7 if N is defined with respect to the set of seven nodes 402, 404, 406, 408, 410, 412, 414. A node 416 represents a log record vector and associated log record that is outside of the window or set (e.g., a log record that is older than the 7th oldest node).

Therefore, as shown, similarity scores may be calculated for each log record vector pair, i.e., for vector pairs 400/402, 400/404, 400/406, 400/408, 400/410, 400/412, and 400/414. Specifically, FIG. 4 illustrates that the node 400 is assigned a similarity score of 0.9 with respect to the node 402, and is assigned a similarity score of 0.5 with respect to the node 404. Similarly, the node pair 400/406 has a similarity score of 0.3, the node pair 400/408 has a similarity score of 0.9, the node pair 400/410 has a similarity score of 0.7, the node pair 400/412 has a similarity score of 0.8, and the node pair 400/414 has a similarity score of 0.6. No similarity score is required to be calculated for the node 416, because the node 416 is outside of the defined window/set.

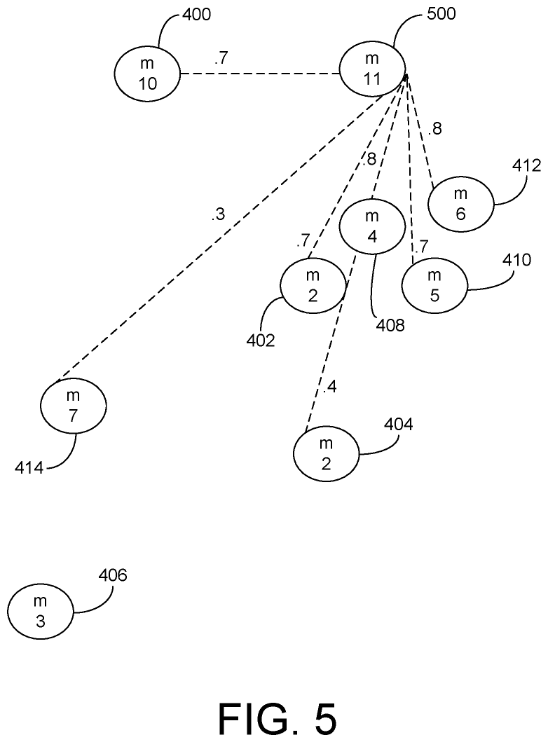

FIG. 4, as well as FIG. 5, generally illustrates similarity scores using corresponding relative distances between pairs of nodes. However, FIGS. 4 and 5 are not necessarily drawn completely to scale, and are included merely for the purposes of illustration and explanation. The various nodes and any connected edges are not required to be representative of any graphical output of operations of the log response manager 102, although such graphical output may be generated.

In various example embodiments, the similarity scores may be calculated using any one or more suitable similarity algorithms. For example, such similarity algorithms may include the string similarity algorithm, the cosine similarity algorithm, or the Log2vec embedding similarity algorithm. Similarity algorithms may also combine text, numeric, and categorical fields contained in log records 106 with assigned weights to determine similarity scores. In the examples provided, similarity scores are assigned a value between 0 and 1, or between 0% and 100%, but other scales or ranges may be used, as well.

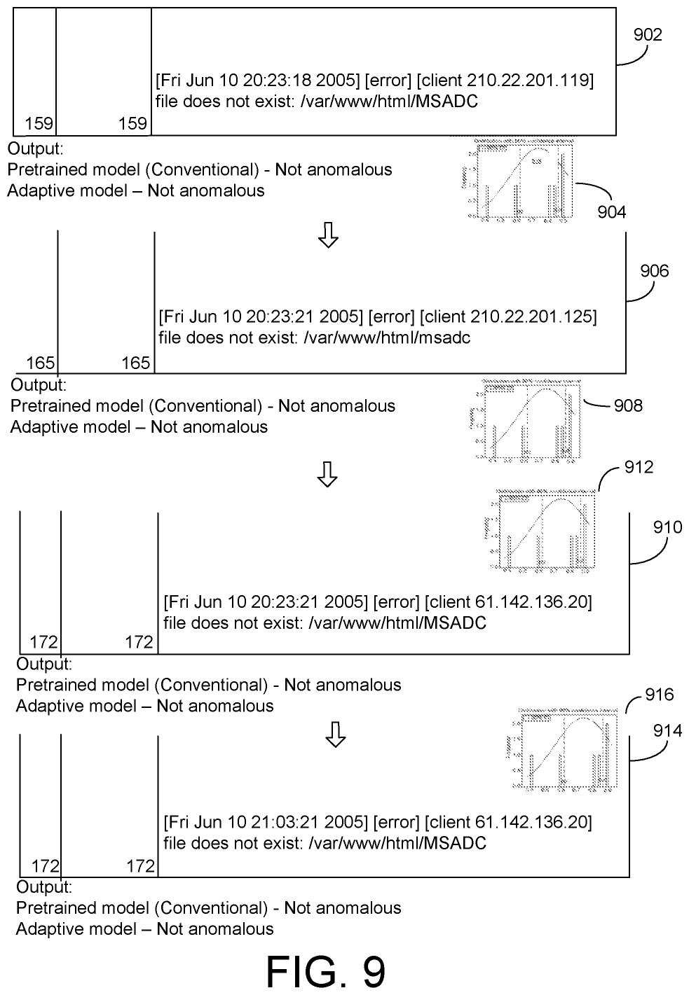

FIG. 4 illustrates that the node 414 is associated with log record text, represented as log record text 415 in FIG. 4. Similarly, the node 406 is illustrated in conjunction with example log record text 407. Such log record text is included merely by way of example, including similar log record text provided with respect to the examples of FIG. 9 through 12. As shown, the log record text 407 and the log record text 415 may generally include a timestamp and text describing a relevant process activity and associated network components and/or resources. In general, such log records 106 may contain a designated structure, such as log level, module name, line number, and a text string describing a corresponding process condition, where such structural elements may be separated by designated characters and/or spaces.

As noted above, for any long running applications, and for many other components of the technology landscape 104, such log records 106 tend to be highly repetitive in nature, although with some differences in structural elements (such as a module name or a line number(s) of structural attributes). The examples of FIG. 4 illustrate the log record text taken from domain controller log records 106 and specifying a timestamp (04/13 05:10:47, a port number (5140), a ping operation of named servers (IN-RAVEYADA) and corresponding access protocol and other network information (Lightweight Directory Access Protocol (LDAP) on user datagram protocol (UDP)).

FIG. 5 illustrates a second example window of embedded log records 106 with similarity scores. In the example of FIG. 5, at a time t2 that occurs after the time t1 of FIG. 4, a node 500 represents a new log record vector for a new, most-recent, or current log record that has been received.

As the new current log record for the node 500 is received, the node 406, representing an oldest or least-recently received log record and associated log record vector, is removed from the window or set of log record vectors. Further, updated similarity scores are generated with respect to remaining nodes, including the node 400 that was previously the anchor node in FIG. 4, with respect to which the various similarity scores were generated.

Thus, in FIG. 5, with the node 500 serving as the anchor node for calculations of similarity scores, the node 500 is assigned a similarity score of 0.7 with respect to the node 402 and is assigned a similarity score of 0.4 with respect to the node 404. Similarly, the node pair 500/408 has a similarity score of 0.8, the node pair 500/410 has a similarity score of 0.7, the node pair 500/412 has a similarity score of 0.8, the node pair 400/414 has a similarity score of 0.3, and the node pair 500/400 has a similarity score of 0.7. No similarity score is required to be calculated for the node 406, since, as previously mentioned, the node 416 is outside of the current window or set.

FIG. 6 illustrates a first example similarity distribution obtained from a similarity series of the types of similarity windows of FIGS. 4 and 5. In the example of FIG. 6, a time-series graph 602 illustrates a similarity series in which embedded log record vectors are graphed in a multi-dimensional (e.g., 300-D) vector space, as a function of time. The graph 602 is illustrated as having a plurality of y-axes, indicating the use of the referenced multi-dimensional embedding space. A similarity series graph 604 graphs a corresponding similarity series for the graph 602, and a graph 606 graphs an example similarity distribution for the similarity series of the graph 604.

In more detail, the graph 602 includes a node 608 representing an anchor or current log record vector, analogous to the anchor node 400 of FIG. 4, or the anchor node 500 of FIG. 5. Thus, a remaining plurality of nodes 610 conceptually corresponds to the nodes 402, 404, 406, 408, 410, 412, and 414 of FIG. 4, or to the nodes 400, 402, 404, 408, 410, 412, 414 of FIG. 5. Consequently, the various similarity scores of the graph 602 conceptually correspond to the various similarity scores of FIG. 4, and/or of FIG. 5.

The graph 604 includes a similarity series 612 that is graphed from the graph 602, in which each similarity score is graphed for a corresponding node of the node 610. The graph 606 illustrates a frequency distribution 614 indicating an extent to which each similarity score appears within the similarity series 612 of the graph 604. As shown, the similarity scores 4, 6, 8, and 85 occur once, while the similarity score 9 occurs twice.

Also in the graph 606, a distribution 616 is calculated that includes a 90% confidence interval 618, defining a lower threshold 62 and an upper threshold 86. In the example, the distribution 616 is right-skewed and corresponds to an increasing trend towards similarity in the similarity series 612 and in the frequency distribution 614. Accordingly, the similarity distribution 614 of the graph 606 may be interpreted to indicate that no anomaly is currently present in the component(s) for which the relevant log records 106 of FIG. 6 are generated.

Additionally, or alternatively, a static threshold, e.g., 8, may be set, which may be defined independently of the distribution 616. Then, for example, a presence of a majority of the similarity scores above the 8 threshold may also be interpreted to indicate that no anomaly is currently present in the component(s) for which the relevant log record of the node 608 of FIG. 6 are generated.

In more specific examples, real-time training for detection of anomalies may be performed, e.g., by using convolutional smoothening and/or thresholding to detect lower and upper thresholds in real time. Then, the thresholds may be used for detecting anomalies; for example, if the frequency distribution 614 is skewed towards the calculated upper threshold as in FIG. 6, then no anomaly is detected. Put another way, the log record (and underlying component(s)) corresponding to the current node 608 is determined to be not anomalous because most of the nodes 610 in the relevant window or set are sufficiently similar to the current node 608.

Many other distribution analyses techniques may be used. For example, distribution analysis may consider a pattern present in the similarity series 612, such as the illustrated pattern of reaching a 9 similarity score at node 2 and node 4. As mentioned above, various statistical analysis techniques may be used, such as a Kalman filter, which attempt to establish an expected or normal similarity distribution, so that a particular similarity distribution, such as the similarity distribution of graph 606, may be compared to the determined expected/normal distribution.

FIG. 7 illustrates a second example similarity distribution obtained from a similarity series of the types of similarity windows of FIGS. 4 and 5. In the example of FIG. 7, a time-series graph 702 illustrates a similarity series in which embedded log record vectors are graphed in a multi-dimensional (e.g., 300-D) vector space, as a function of time, as in the graph 602 of FIG. 6. A similarity series graph 704 graphs a corresponding similarity series for the graph 702, and a graph 706 graphs an example similarity distribution for the similarity series of the graph 704.

In more detail, the graph 702 includes a node 708 representing an anchor or current log record vector, analogous to the anchor node 400 of FIG. 4, or the anchor node 500 of FIG. 5. Thus, a remaining plurality of nodes 710 conceptually corresponds to the nodes 402, 404, 406, 408, 410, 412, and 414 of FIG. 4, or to the nodes 400, 402, 404, 408, 410, 412, 414 of FIG. 5. Consequently, the various similarity scores of the graph 702 conceptually correspond to the various similarity scores of FIG. 4, and/or of FIG. 5.

The graph 704 includes a similarity series 712 that is graphed from the graph 702, in which each similarity score is graphed for a corresponding node of the nodes 710. The graph 706 illustrates a frequency distribution 714 indicating an extent to which each similarity score appears within the similarity series 712 of the graph 704. As shown, the similarity scores 3, 4, 45, 5, 6, and 9 each occur once.

Also in the graph 706, a distribution 716 is calculated that includes a 90% confidence interval 718, defining a lower threshold 4 and an upper threshold 65. In the example, the distribution 716 is left-skewed and corresponds to a decreasing trend towards similarity in the similarity series 712 and in the frequency distribution 714. Accordingly, the similarity distribution 714 of the graph 706 may be interpreted to indicate that an anomaly is currently present in the component(s) for which the relevant log record of the node 708 is generated. In other words, in contrast with the example of FIG. 6, FIG. 7 illustrates a potentially anomalous state in which the distribution 716 is skewed away from an upper threshold (e.g., 8), demonstrates a decreasing trend, i.e., towards dis-similarity.

In a particular distribution analysis example, a Kullback-Leibler (KL) divergence analysis may be used, which measures (using a unit measure known as nats) an extent to which one probability distribution differs from another. In the example of FIG. 7, for example, a KL divergence of 2.260 nats may be determined, indicating a divergence from a normal or expected distribution, and again consistent with detection of an anomaly in FIG. 7.

Thus, as illustrated and described with respect to FIGS. 6 and 7, an earlier similarity distribution for an earlier log record vector and earlier set of log record vectors may be determined, so that an anomaly may be detected using a comparison of the similarity distribution and the earlier similarity distribution. In other words, earlier anchor nodes and nodes of a corresponding earlier or preceding window of nodes may provide an earlier or preceding similarity distribution(s) that may be used to judge a current similarity distribution.

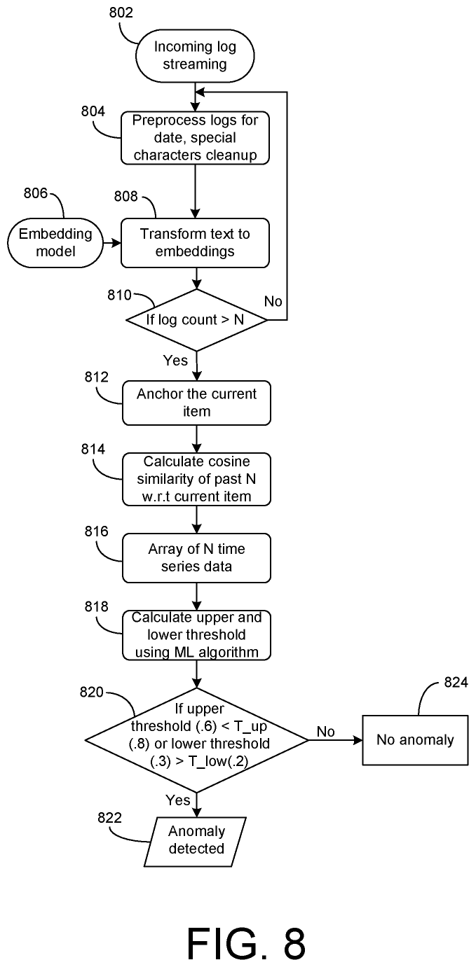

FIG. 8 is a more detailed flowchart illustrating example operations for FIGS. 3 through 7. In the example of FIG. 8, an incoming log record stream is received (802). The log records may be pre-processed (804) to remove dates and other special characters not needed for, or detrimental to, the types of log record analysis described herein.

Then, an embedding model 806 may be used to transform text of the pre-processed log records into embeddings (808), i.e., into the log record vectors described herein. If a count of currently-received log records is less than a defined window or set size N (810), then pre-processing (804) and transformations (808) may continue.

If the Nth log record is reached (810), the current log record vector may be anchored (812). Cosine similarities for each pair of anchor log record vector and past N log record vector(s) may then be calculated (814) to determine an array of N time series data (816).

Lower and upper thresholds may then be calculated for a corresponding similarity distribution (818), e.g., using an appropriate ML algorithm, for example, the Kalman filter. If the calculated upper threshold is less than a defined upper threshold, or if the calculated lower threshold is greater than a defined lower threshold (820), then an anomaly is detected (822). Otherwise, no anomaly is detected (824).

FIGS. 9 through 12 illustrate example log records 106 analyzed using described techniques, compared to analysis of the same log records 106 using conventional techniques. In the examples, a sample set of log records 106 are used from domain controller logs, similar to the example log records 407, 415 of FIG. 4. Also in the examples, a conventional pre-trained model was used to analyze the various log records 106 for anomalies, while the described techniques, using a window length of 200 log records, were also used to analyze the same log records 106 for anomalies.

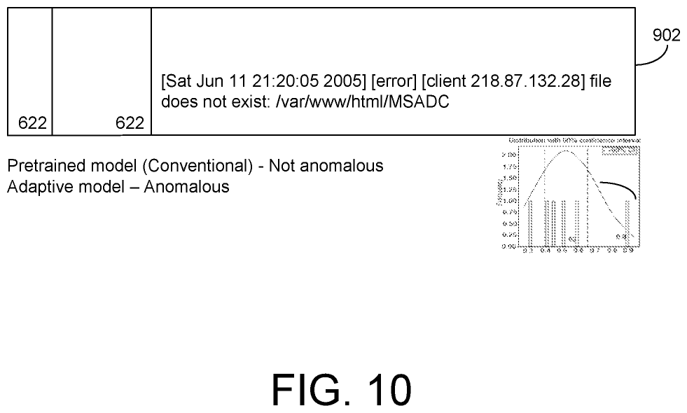

FIGS. 9 and 10 illustrate an example in which the conventional pre-trained model and the described adaptive model initially obtain similar results in FIG. 9 as shown by similar curves shifted right, but then diverge as the pre-trained model continues to identify non-anomalous results in FIG. 10, while the described adaptive techniques detect an anomaly as shown by the curve shifted left.

More specifically, in FIG. 9, for a log record 902, a similarity distribution 904 obtained using described techniques indicates a “not anomalous” state, which corresponds to a result of “not anomalous” obtained using a conventional pre-trained model, as shown. Similarly, for a log record 906, a similarity distribution 908 obtained using described techniques indicates a “not anomalous” state, which corresponds to a result of “not anomalous” obtained using a conventional pre-trained model, as shown.

Further in FIG. 9, for a log record 910, a similarity distribution 912 obtained using described techniques indicates a “not anomalous” state, which corresponds to a result of “not anomalous” obtained using a conventional pre-trained model, as shown. Finally in FIG. 9, for a log record 914, a similarity distribution 916 obtained using described techniques indicates a “not anomalous” state, which corresponds to a result of “not anomalous” obtained using a conventional pre-trained model, as shown.

In contrast, in FIG. 10, a log record 1002 is associated with a similarity distribution 1004 obtained using described techniques that indicates an “anomalous” state, while a result of “not anomalous” is obtained using a conventional pre-trained model, as shown. In other words, the type of adaptive model described herein is effectively learning in a continuous manner and is updated at each new anchor log record and associated window of log records 106. In contrast, conventional pre-trained models must be re-trained to detect new types of abnormal, anomalous results, and such training can not be practically or effectively performed at sufficiently frequent intervals. Therefore, as shown in FIGS. 9 and 10, described adaptive techniques are capable of detecting anomalous results that may be missed by conventional techniques.

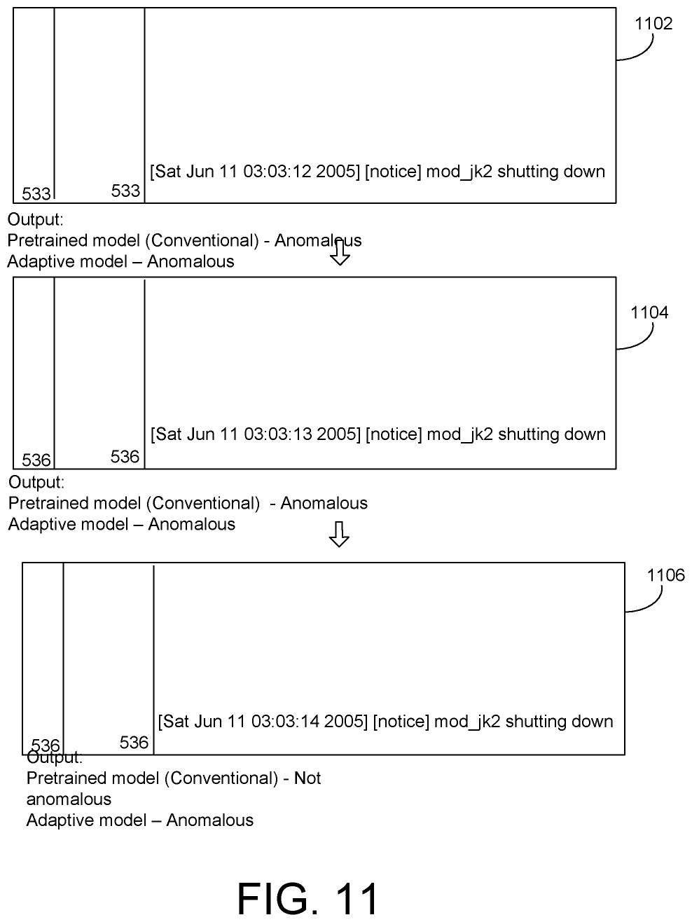

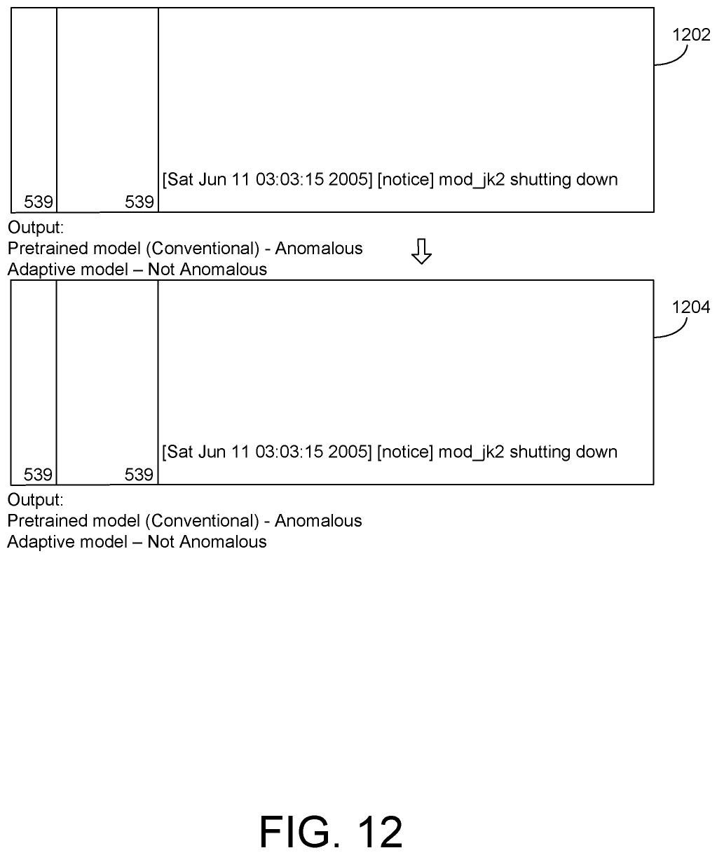

FIGS. 11 and 12 demonstrate a similar but inverse example, in which both conventional and current techniques detect anomalous states in log record 1102, log record 1104, and log record 1106 in FIG. 11. Then, in FIG. 12, presently described adaptive techniques detect non-anomalous states in log record 1202 and log record 1204, while conventional techniques erroneously continue to detect an anomalous state.

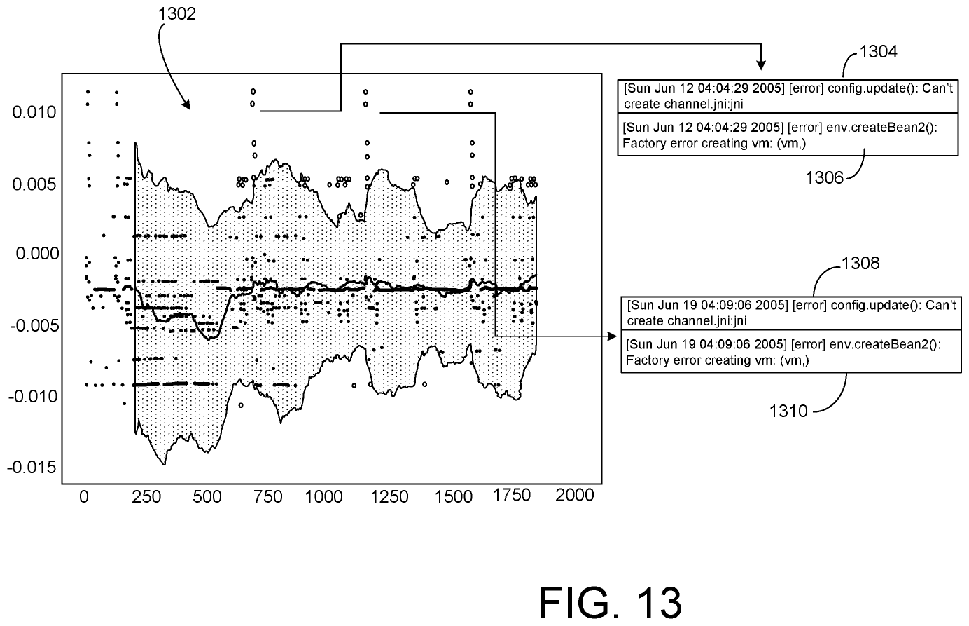

FIG. 13 is a graph illustrating logs graphed in time-embedding space for pattern insights. As shown, log record 1304 and log record 1306 correspond to two outliers occurring on Sunday June 12 around 4 am. Similarly, log record 1308 and log record 1310 correspond to two outliers occurring on Sunday June 19 around 4 am. Thus, FIG. 13 illustrates that described techniques may be used over larger time windows (e.g., days, weeks, or months) to detect potential anomalies that may demonstrate a time-series pattern across such time frames.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, a mainframe computer(s), or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive textual log records characterizing operations occurring within a technology landscape;
convert the textual log records into numerical log record vectors;
compute, for a current log record vector and a preceding set of log record vectors of the numerical log record vectors, a similarity series that includes a similarity measure for each of a set of log record vector pairs, wherein each log record vector pair includes the current log record vector and one of the preceding set of log record vectors;
generate a similarity distribution of the similarity series; and
detect an anomaly in the operations occurring within the technology landscape, based on the similarity distribution.

2. The computer program product of claim 1, wherein the instructions, when executed, are further configured to cause the at least one computing device to:
process the textual log records with an embedding model to convert the textual log records into the numerical log record vectors.

3. The computer program product of claim 1, wherein the similarity measure includes a similarity score calculated using a cosine similarity algorithm.

4. The computer program product of claim 1, wherein the instructions, when executed, are further configured to cause the at least one computing device to:
calculate the similarity distribution as a frequency distribution measuring a frequency of each similarity measure of the similarity series.

5. The computer program product of claim 1, wherein the instructions, when executed, are further configured to cause the at least one computing device to:
determine at least one similarity threshold for the similarity distribution; and
determine the anomaly, based on the similarity distribution and the at least one similarity threshold.

6. The computer program product of claim 1, wherein the instructions, when executed, are further configured to cause the at least one computing device to:
determine a similarity trend of the similarity distribution; and
determine the anomaly, based on the similarity distribution and the similarity trend.

7. The computer program product of claim 1, wherein the instructions, when executed, are further configured to cause the at least one computing device to:
determine an earlier similarity distribution for an earlier log record vector and earlier set of log record vectors; and
determine the anomaly, based on a comparison of the similarity distribution and the earlier similarity distribution.

8. The computer program product of claim 7, wherein the instructions, when executed, are further configured to cause the at least one computing device to:
apply a Kalman filter to the similarity distribution and the earlier similarity distribution to determine the anomaly.

9. The computer program product of claim 7, wherein the instructions, when executed, are further configured to cause the at least one computing device to:
apply a Kullback-Leibler (KL) divergence analysis to the similarity distribution and the earlier similarity distribution to determine the anomaly.

10. The computer program product of claim 1, wherein the instructions, when executed, are further configured to cause the at least one computing device to:
detect the anomaly in a component for which a current log record of the current log record vector was generated.

11. A computer-implemented method, the method comprising:
receiving textual log records characterizing operations occurring within a technology landscape;
converting the textual log records into numerical log record vectors;
computing, for a current log record vector and a preceding set of log record vectors of the numerical log record vectors, a similarity series that includes a similarity measure for each of a set of log record vector pairs, wherein each log record vector pair includes the current log record vector and one of the preceding set of log record vectors;
generating a similarity distribution of the similarity series; and
detecting an anomaly in the operations occurring within the technology landscape, based on the similarity distribution.

12. The method of claim 11, further comprising:
processing the textual log records with an embedding model to convert the textual log records into the numerical log record vectors.

13. The method of claim 11, further comprising:
calculating the similarity distribution as a frequency distribution measuring a frequency of each similarity measure of the similarity series.

14. The method of claim 11, further comprising:
determining at least one similarity threshold for the similarity distribution; and
determining the anomaly, based on the similarity distribution and the at least one similarity threshold.

15. The method of claim 11, further comprising:
determining a similarity trend of the similarity distribution; and
determining the anomaly, based on the similarity distribution and the similarity trend.

16. The method of claim 11, further comprising:
determining an earlier similarity distribution for an earlier log record vector and earlier set of log record vectors; and
determining the anomaly, based on a comparison of the similarity distribution and the earlier similarity distribution.

17. A system comprising:
at least one memory including instructions; and
at least one processor that is operably coupled to the at least one memory and that is arranged and configured to execute instructions that, when executed, cause the at least one processor to:
receive textual log records characterizing operations occurring within a technology landscape;
convert the textual log records into numerical log record vectors;
compute, for a current log record vector and a preceding set of log record vectors of the numerical log record vectors, a similarity series that includes a similarity measure for each of a set of log record vector pairs, wherein each log record vector pair includes the current log record vector and one of the preceding set of log record vectors;
generate a similarity distribution of the similarity series; and
detect an anomaly in the operations occurring within the technology landscape, based on the similarity distribution.

18. The system of claim 17, wherein the instructions, when executed, are further configured to cause the at least one processor to:
process the textual log records with an embedding model to convert the textual log records into the numerical log record vectors.

19. The system of claim 17, wherein the instructions, when executed, are further configured to cause the at least one processor to:
determine at least one similarity threshold for the similarity distribution; and
determine the anomaly, based on the similarity distribution and the at least one similarity threshold.

20. The system of claim 17, wherein the instructions, when executed, are further configured to cause the at least one processor to:
determine an earlier similarity distribution for an earlier log record vector and earlier set of log record vectors; and
determine the anomaly, based on a comparison of the similarity distribution and the earlier similarity distribution.
